(19) United States
(12) Patent Application Publication
(10) Pub. No.: US 2011/0043374 A1
(43) Pub. Date: Feb. 24, 2011

(54) COMMUNICATION METHODS AND DEVICES

(75) Inventors: Stuart Ross Bannister, Victoria (AU); Song Cui, Victoria (AU)

Correspondence Address: MH2 TECHNOLOGY LAW GROUP, LLP, 1951 KIDWELL DRIVE, SUITE 550, TYSONS CORNER, VA, 22182, US

(73) Assignee: Semitech Innovarins Pty Ltd

(21) Appl. No.: 12/668,486

(22) PCT Filed: Jul. 9, 2008
(86) PCT No.: PCT/AU08/01002

§ 371 Date: Nov. 8, 2010

(30) Foreign Application Priority Data
Jul. 9, 2007 (AU) 2007903688

(51) Int. Cl. G08C 15/02; H04B 1/38

(52) U.S. Cl. 340/870.02; 375/219; 375/223

(57) ABSTRACT

In one arrangements there is provided a communications method (10). The method (10) includes sending data (14) in a phase shift keyed form (16) over a power line carrier (22) and sending the same data (14) in a frequency shift keyed form (20) over the same power line carrier (22).

### FIELD OF THE INVENTION

The present invention relates to the field of communication methods and devices. In particular arrangements the present invention relates to the field of power line communication networks.

The disclosure of Australian Provisional Application 2007903688, filed 10 Jul. 2007, from which priority is claimed, is hereby fully incorporated by reference, in its entirety, and for all purposes.

The disclosure of related application PCT/AU2006/000530, filed 26 Apr. 2006, is hereby fully incorporated by reference, in its entirety, and for all purposes.

### BACKGROUND ART

Power line networks in many countries have a large number of houses connected to a single distribution transformer. In networks of this kind an automatic meter reading interval of 30 minutes may necessitate a transaction completion time of a less than a few seconds. In such systems repeating is often needed due to attenuation and interferences. This means that completing the readings may not be accomplished within the requisite meter reading interval. The problems of attenuation that exist at higher frequencies, the presence of large transients, increased cost and limitations due to spectrum allocation in different countries means that the use of higher data rate system in addressing the issue of completing the readings within the requisite time, is either typically difficult to implement or not suitable for automatic meter reading.

Simple communications systems over power lines are often unable to communicate at all in the face of many common types of noise. This arises because the power line is an inhospitable communications medium in which noise sources exist such as tones produced by power supplies, impulses, random voltage fluctuations, periodic bursts and so forth. Other common problems include attenuation and severe loading which also make transmission difficult.

The above problems are often readily observable however this is not the case with noise in the form of line impedance fluctuation. Line impedance fluctuation is caused by devices conducting during certain parts of the mains cycle and not others. The changing of impedance has two undesirable effects. Firstly, the amplitude of the received signal will often change wildly and in some cases abruptly. This means that any amplitude information is unreliable and can cause problems with gain control systems. Secondly, phase information encoded in carrier signals can be distorted by the impedance change due to the phase delay introduced by capacitive and inductive elements.

Abrupt impedance variation can make binary phase shift keying demodulation virtually impossible due to the fact that all of the information is encoded in the phase. Furthermore, the phase variation can often look like valid data when demodulated.

Another common source of interference on the power line is tonal noise. Traditional power line systems contain dual band systems where the second channel is used as redundant channel to overcome the noise. Tonal noise from devices such as switch mode power supplies conduct harmonics onto the power line that often block communications on a single carrier frequency. Early power line communication devices had single frequency operation and had the problem of never being able to communicate on power line networks if such switching power supplies existed. Today switching power supplies are very common making up the majority used for computers, battery chargers, electronic light ballasts and other household items.

Problems also exist with severe notches in the power line frequency response from point to point. This can produce attenuation of up to 80 dB in one band and almost no attenuation in the next.

Some systems attempt to address the problem of noise and impedance fluctuations, by encoding information into each byte to detect if a phase inversion has occurred. Systems of this type have provided only limited success.

It is an object of the embodiments described herein to overcome or alleviate at least one of the above noted drawbacks of related art systems or to at least provide a useful alternative to related art systems.

Throughout this specification the use of the word “inventor” in singular form may be taken as reference to one (singular) inventor or more than one (plural) inventor of the present invention. The discussion throughout this specification comes about due to the realisation of the inventor(s) and/or the identification of certain prior art problems by the inventors.

Any discussion of documents, devices, acts or knowledge in this specification is included to explain the context of the invention. It should not be taken as an admission that any of the material forms a part of the prior art base or the common general knowledge in the relevant art in Australia or elsewhere on or before the priority date of the disclosure and claims herein.

### SUMMARY OF INVENTION

According to a first aspect of arrangements herein described there is provided a power lines communication device comprising a communications unit having a first channel unit and a second channel unit wherein the channel units are adapted, in a first mode of operation, to receive simultaneously and/or transmit simultaneously.

In embodiments of the first aspect the communications unit is adapted to receive simultaneously and/or transmit simultaneously in a metering network comprising two subnetworks isolated by frequency division and complete transactions within a predetermined transaction time.

According to a second aspect of arrangements herein described there is provided a metering network comprising a plurality of subnetworks isolated by frequency division.

In embodiments of the second aspect the subdivision of the subnetworks by frequency division allows for improved transaction times for automatic meter reading.

According to a third aspect of arrangements herein described there is provided a metering network having utility traffic and consumer traffic isolated by frequency division.

In embodiments of the third aspect the isolation of utility traffic and consumer traffic allows for the allocation of carrier frequency ranges and a separation of transaction completion times.

According to a fourth aspect of arrangements herein described there is provided a data communications method comprising: sending data in a phase shift keyed form; and sending data in a frequency shift keyed form.

According to a fifth aspect of arrangements herein described there is provided a data communications device comprising: a phase modulation facility for sending data in a phase shift keyed form; and a frequency modulation facility for sending data in a frequency shift keyed form.

In embodiments of the fourth and fifth aspects, embodiments address the problem of impedance variation in power line metering networks in that, in one form, the phase shift keyed form comprises a binary phase shift keyed form and the frequency shift key form comprises a relatively phase independent frequency shift keyed form.

According to a sixth aspect of arrangements herein described there is provided a method of filtering comprising providing a first filter; providing a second filter, and selectively coupling the first and second filters to form a coupled filter.

In embodiments of the sixth aspect fewer coefficients are needed for the equivalent filter bandwidth as well as fewer registers for storage. Furthermore, each filter can be sub-divided and reconfigured to realise two separate narrow band filters or combined to form a higher order single filter. The reconfigurability and reuse of logic has the benefit of significant area and cost savings.

According to an seventh aspect of arrangements herein described there is provided a method of querying a plurality of utility meters comprising: maintaining a record of divisions of the utility meters; querying a first division of the divisions in accordance a first signalling method; and querying a second division of the divisions in accordance with a second signalling method.

According to a eighth aspect of arrangements herein described there is provided a device for querying a plurality of utility meters comprising: a store for maintaining a record of divisions of the utility meters; and a query unit having a first facility for querying a first division of the divisions in accordance a first signalling method and a second facility for querying a second division of the divisions in accordance with a second signalling method.

In embodiments of the seventh and eighth aspects the first signalling method comprises phase shift keying and the second signalling method comprises frequency shift keying in order to address the problem of line impedance variation.

According to an ninth aspect of arrangements herein described there is provided a method of detecting a frequency change comprising: correlating for frequency; detecting an edge; and determining a frequency change on the basis of said correlating for frequency and detecting an edge.

In embodiments of the ninth aspect erroneous frequency changes detected by correlation are advantageously limited by concurrently checking for an edge transitions.

Other aspects and preferred aspects are disclosed in the specification and/or defined in the appended claims, forming a part of the description. It is to be appreciated that an aspect embodied in a system may be embodied in a method and vice versa. For example in one aspect there is provided a method of querying an automatic meter reading system wherein querying a subnet of nodes comprises providing a time parameter. In another aspect there is provided an automatic meter reading system having a number of subnets of nodes wherein each node is provided with a predetermined parameter indicative of a time slot unique to that node in the subnet.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

Further disclosure, objects, advantages and aspects of the present application may be better understood by those skilled in the relevant art by reference to the following description of preferred embodiments taken in conjunction with the accompanying drawings, which are given by way of illustration only, and thus are not imitative of the present invention, and in which:

FIG. 1 is a schematic view of a device according to a first preferred embodiment of the present invention;

FIG. 2 is an illustration of the operation of the device shown in FIG. 1;

FIG. 3 is an illustration of a preferred use of the device shown in FIG. 1 according to a second embodiment of the present invention;

FIGS. 4 to 6 provide illustrations of a preferred system according to another embodiment of the present invention;

FIG. 7 is an illustration of a compensation method used in the system shown in FIGS. 4 to 6;

FIG. 8 is an illustration of the system shown in FIGS. 4 to 7;

FIG. 9 is an illustration of an error reporting method used in the system shown in FIGS. 4 to 7;

FIG. 10 is a further illustration of the system shown in FIGS. 4 to 7;

FIG. 11 is an illustration detailing the operation of elements shown in FIG. 10;

FIG. 12 is an illustration of another preferred use of the device shown in FIG. 1 according to a another embodiment of the present invention;

FIG. 13 is an illustration of a mode of operation of the device shown in Figure according to a another embodiment of the present invention;

FIG. 14 is a schematic view of a device according to a another embodiment;

FIG. 15 is a schematic view of a device according to a another embodiment;

FIGS. 16 to 18 are schematic views of a signal filter according to yet another embodiment of the present invention, the filter being used in the embodiment shown in FIG. 15

FIG. 19 is a schematic of a demodulation system according to another embodiment of the present invention.

FIG. 20 is schematic view of a modulation system according to yet another embodiment;

FIG. 21 is a simplified view of a modulation method according to a further embodiment of the present invention.

FIG. 22 is a schematic view of a further modulation according to a further embodiment of the present invention; and

FIG. 23 is a schematic view of a system shown in FIG. 22;

### DETAILED DESCRIPTION

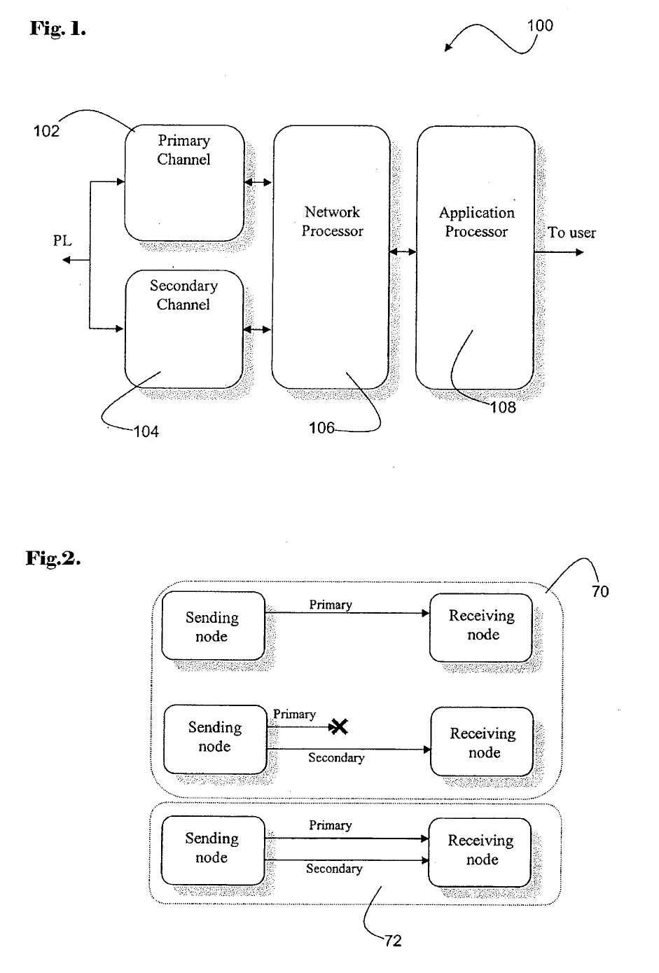

Referring to FIG. 1 there is shown a system in the form of a communications device 100 according to a first preferred embodiment of the present invention. The system contains two independent channels that can be used in a variety of ways. The two main uses of the system are to avoid noise or to double the amount of data that can be transferred. The system is considered to be unique to power line communications as the two channels provided are completely independent from each other and can receive simultaneously as well as transmit simultaneously. Other uses of the system relate to network isolation through frequency division or providing communications between parts of the spectrum that are allocated for specific uses. An example comprises A and C bands defined and allocated in the CENELEC 50065-1 standard.

As shown in FIG. 1 the device 100 contains two independent channels 102 & 104, a network processor 106, and an application processor 108. Traditional dual carrier systems cannot receive or transmit simultaneously on two bands when there are two incoming packets on two different channels. Some systems overcome this problem by sending out a tone on the primary channel (the main channel) to essentially block transmitters from transmitting while there is a packet being sent on the secondary channel at a different frequency. FIG. 2 demonstrates the differences between a basic dual band system 70 and a basic dual channel system 72 according to the embodiment described.

As noted above many current automatic meter reading systems demand a high data throughput due to regular readings of large meter networks. Power line networks in many countries have a large number of houses connected to a single distribution transformer. In a network with 500 meters attached and a reading interval of 30 minutes transactions must completed in less than 3.6 seconds. In a system where repeating is needed due to attenuation or interference, transactions can often take longer than this time to complete. The device 100 is advantageously able to provide an improvement to the average transaction time.

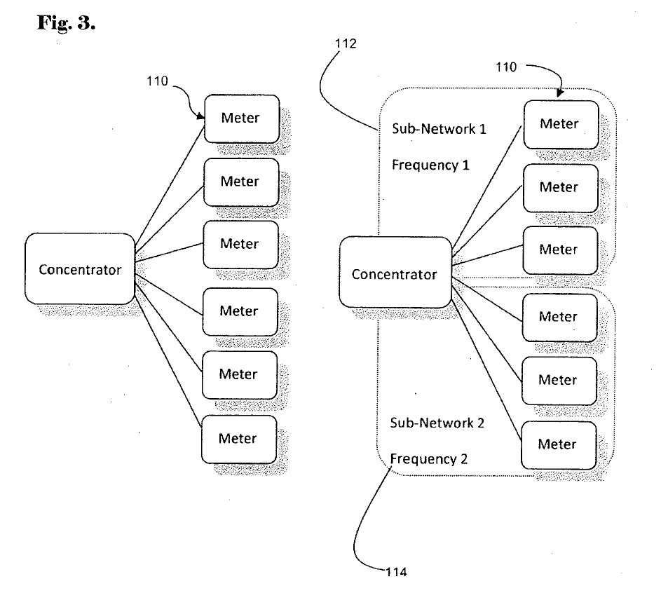

Another advantage of a dual receiver form of the device 100 is that it is possible to segment a network 110 into two different sub networks 112, 114 shown in FIG. 3. The two sub networks are configured to operate on different frequencies and are isolated from each other to provide a doubling of the data throughput. The isolation has the benefit of lowering traffic for routers and avoiding collisions on the shared medium. FIG. 3 demonstrates the differences between a network that contains a dual band single receiver and transmitter and a simultaneous dual receiver transmitter (channel) that is used to isolate the networks. More than one division of the network 110 may be provided although two are presently preferred.

The two independent channels 102, 104 can in other preferred arrangements be used to isolate utility traffic and consumer traffic. There are special cases in which this is advantageous including those that allow a meter to be read by both the consumer, for the purpose of monitoring electricity usage, and the utility for the purpose of reading the meter for use in billing. In Europe certain frequency ranges are designated for use by utilities which make frequency division of the first and second networks suitable.

When dealing with low data rate communication products many network providers of real time monitoring AMR systems are concerned with communication performance and throughput.

Preferred arrangements of the present invention have been designed with these concerns in mind, in view of problems associated with narrow band power line transceivers.

Prior art dual band and single band transceivers are typically inflexible and have limited throughput. Embodiments of the invention advantageously allow the MAC to be disabled; provide for concurrent operation on two frequencies to provide higher data rates in comparison with typical prior art single or dual band systems; use relatively low overheads in circumstances in which overheads are known to lower information throughput; and provide for redundancy when communications are jammed due to noise on the power line.

The impact of noise has been seen by the inventors to be a major issue in trials and to be the cause of poor communication distances.

Preferred embodiments of the present invention are considered to provide a speed increase of somewhere in the order of 4 times over the main traditional low data rate AMR schemes. An example of a system of 500 meters is provided below.

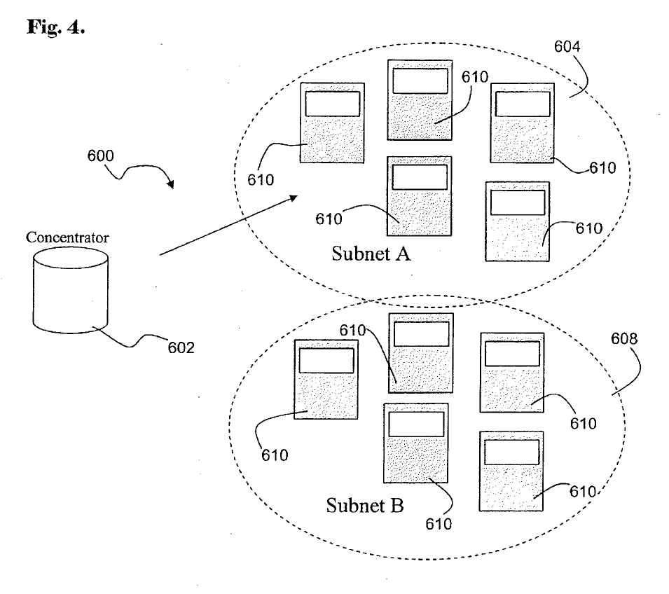

One advantageous system according to a preferred embodiment is illustrated in FIGS. 4, 5 and 6. The preferred embodiment provides an automatic meter reading query and response system. Advantageously the system allows for various meter reading nodes to provide responses in accordance with one or more time based parameters. In the embodiment a concentrator 602, connected to a plurality of subnets 604, 608, specifies a time based parameter. The time based parameter is read by each of the nodes which use predetermined criteria in determining a response waiting time.

It is considered that the automatic reader system advantageously reduces overhead by providing an ordered priority slotting system.

In terms of a grouping of electronic meter nodes 610, the system of nodes is divided into subnets including subnets 604 and 608. This is illustrated in FIG. 4.

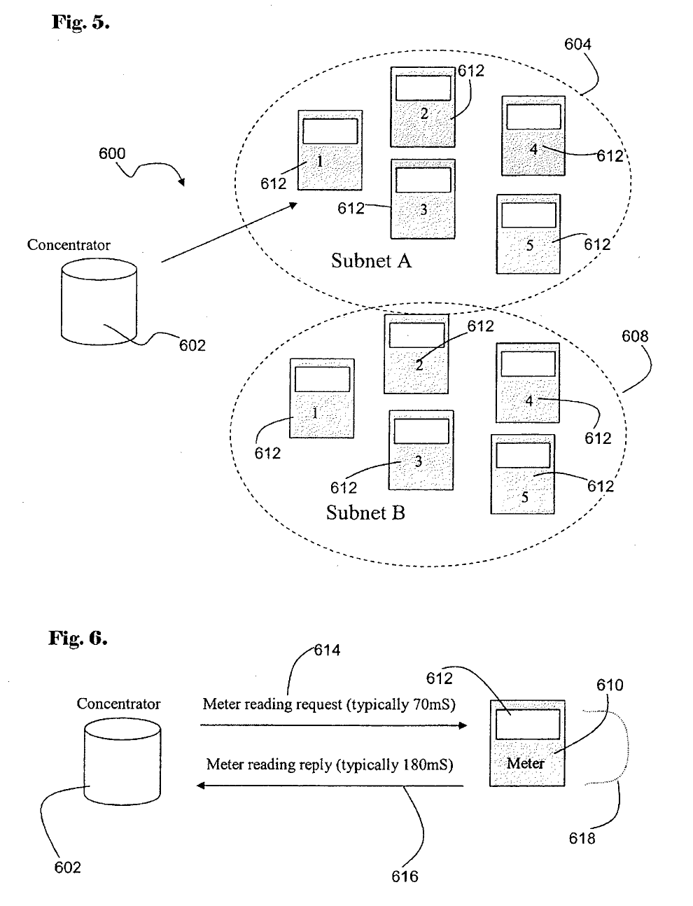

During the network discovery stage each member node 610 of the subnet is given a priority number 612, shown in FIG. 5. For each of the members 610 the priority number 612 is unique in each of the subnets. The same priority number may be given to different node 610 in different subnets.

The priority numbers in the arrangement are sequential commencing at the number 1. This is shown in FIG. 5.

As shown in FIG. 6, querying between the concentrator and any one of the nodes 610 would typically have an average forward journey time 614 and an average return journey time 616.

Unlike the prior art, the system 600 provides for the introduction of a desired time 618 allowing for a time spaced sequence of replies from the nodes 610 in each subnet.

In the system 600, the concentrator 602 has a store of expected time of reply values. The concentrator 602 commences the query process by issuing a request. The request includes a parameter that is embedded into the request.

The parameter comprises a time parameter that allows the concentrator to manipulate the overall time taken for reply from each of the subnets. The time parameter in the arrangement comprises a scaling parameter that scales the desired time 618 between the forward journey time 614 and the return journey time 616.

In the system the subnets are chosen such that subnets form common group types of meters with known response times. The subdivision provides for the priority slotting and, advantageously, for the overall response time of the network to be faster.

For example, if one were to query 500 nodes then it would not possible to cancel the transaction until all of the meters have replied. Consequently disconnects and other manual tasks can happen with a substantially faster response time.

When the concentrator sends the request it knows the expected time of the reply by querying a database. This time is embedded into the request. When the request is received by the meter a timer is started. The time in which the meter replies is prescribed by the formula:

Reply slot start=priority slot number 612*reply time

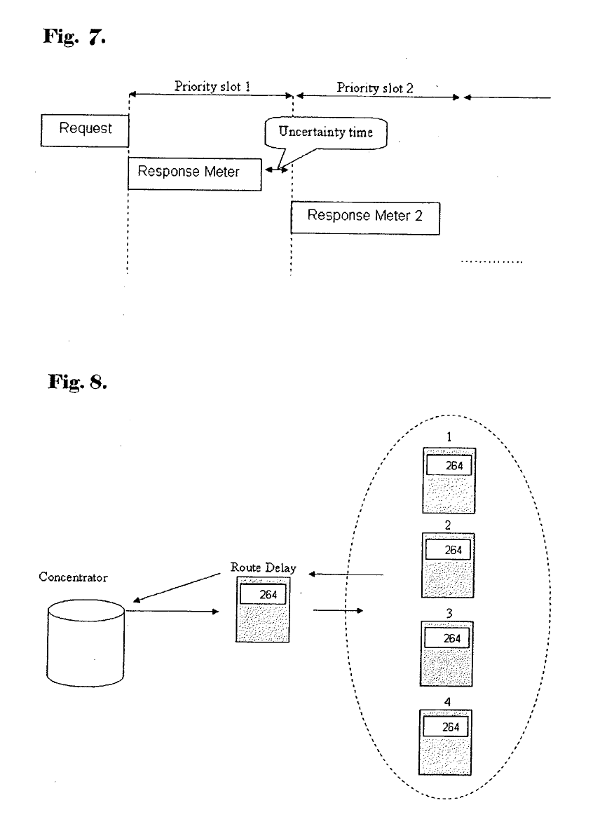

In the formation of subnets, the method divides meters that can be reached directly and nodes that require a certain levels of routing. There is a certain amount of uncertainty time associated with reception and transmission. In the embodiment, this uncertainty time is in the range of 2-3 ms and predominately caused by reception offsets and varying processing delays. This value is added onto the slot time so that collisions do not occur. FIG. 7 illustrates the width of the time slots taking into account the uncertainty time.

The system 600 is adapted to adjust for routing delay. For this purpose the concentrator has access to route path details and knows how many hops are taken before a query reaches the destination. Consequently the time slot is determined by the following formula:

Routed reply slot time=(reply time*number of hops)+(routing delay*number of hops)

This time is embedded into the packet. FIG. 8 illustrates the concept.

An example network of 500 meters and one, two three routes comprising 150, 100, 100 and 150 meters is provided below.

Before considering the example it is important to note that in the system 600 exceptions can occur when the actual transmitted packet is going to be larger than the slot allocated. This can happen as error flags such as tamper and malfunction are sometimes appended to the end of the packet during a normal meter reading.

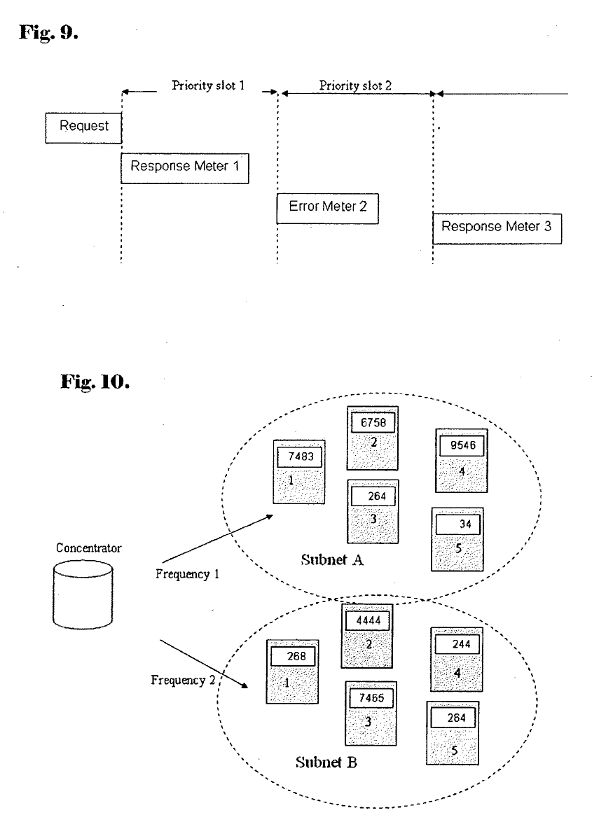

If this occurs the meter calculates the length of the packet and if it is longer than the slot, a short error packet is sent instead. The error state is shown in the FIG. 9.

If there is no reply from a particular meter during its slot then it is recorded and retried individually after the transaction has been completed. In addition, manual events can be scheduled after the transaction has been completed.

In the system each node containing an embodiment of the present invention has the ability to send and transmit on two channels simultaneously.

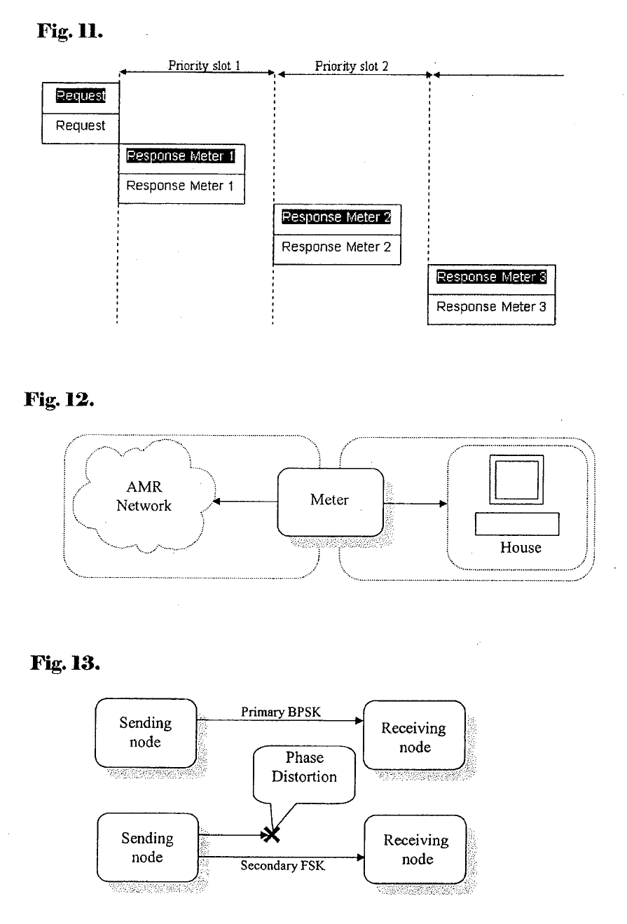

This means that the throughput is effectively doubled. The two frequencies that the channels operate can be either close together or apart from each other. This is generally decided upon the packet error rate on the frequencies. FIG. 10 illustrates concept.

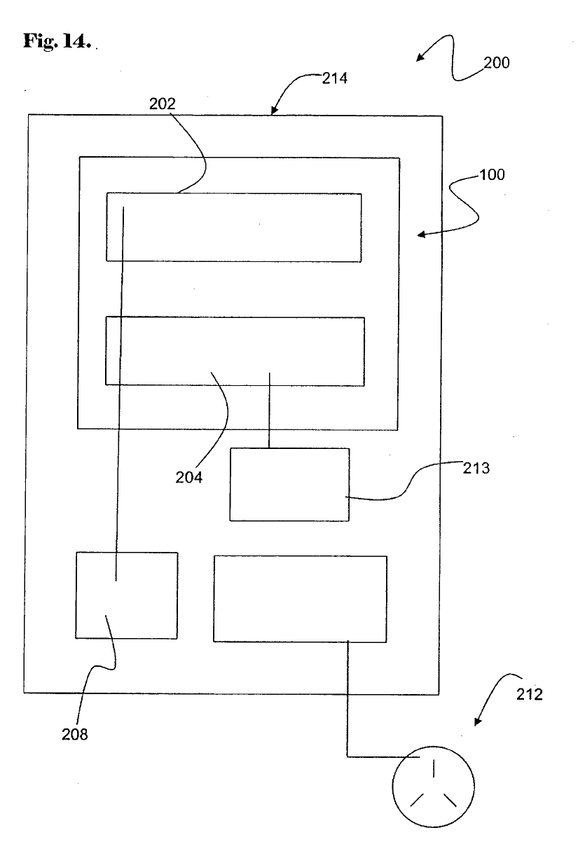

FIG. 11 shows a timeline of how the slot system along with frequency division works. The redundant channel still exists as the other frequency to that allocated for the subnet is a back path. Subnet A is shown with darkened highlighting.

### Example Network

An example of the time taken to read 500 meters in a preferred AMR system is provided. Notably, the calculations are simplified and only take into account basic errors and otherwise demonstrate the operation of the system. The calculations are as follows:

### Assumptions

| | |
|---|---|
| Frequency A | 86 kHz (3591 bps) |
| Frequency B | 79 kHz (3306 bps) |
| Request Time | 70 ms |
| Response Time | 200 ms (50 bytes overestimation) |
| Average packet error rate | 10% |
| Percentage no routes | 30% (150 meters) |
| Percentage one route | 20% (100 meters) |
| Percentage two routes | 20% (100 meters) |
| Percentage three routes | 30% (150 meters) |
| Subnet size | 25 meters |
| Route delay | 2 ms |

Note:
transmission times are taken at the lowest speed (3306 bps).

### DEFINITIONS

| Name | Value | Description |
|---|---|---|
| T_{request} | 70 ms | Request time |
| Tᵣₑₛₚₒₙₛₑ | 200 ms | Response time |
| N_{totalSubnets} | 20 | Total number of Subnets in the network. |
| N_{subnet} | | Number Of Subnets in example |
| N_{nodes} | 25 | Number of nodes in a subnet (Subnet Size) |
| N_{totalNodes} | 500 | Total Number of nodes on the network |
| T_{transaction} | | Transaction time |
| T_{transNoRoute} | | Transaction time no routes |
| PER | 10% | Packet Error Rate |
| T_{RouteDelay} | 2 ms | Time between receiving a packet, processing and |
| | | sending a packet onto the power line for routing |

In all calculation the communications frequency is assumed to be the A-Band master frequency of 86 kHz.

### No Routes

$$\begin{matrix}{T}_{transNoRoute} = {T}_{request} + ( {T}_{response} * {N}_{Nodes} ) + \\ ( PER * {N}_{nodes} * ( {T}_{request} + {T}_{response} ) ) \\ = 70 ms + ( 200 ms * 25 ) + ( 10 \% * 25 * 270 ms ) \\ = 5 , 745 ms or 5.7 seconds\end{matrix}$$

There are 6 subnets that do not need to be routed therefore:

$${N}_{subnet} = {N}_{totalSubnets} * 30 \% = 6$$

$$\begin{matrix}No route total time = ( {N}_{subnet} * {T}_{transNoRoute} ) / 2 \\ = 17 , 235 ms or 17.2 seconds \end{matrix}$$

### One Route

T_{transaction}=((T_{request}+(Tᵣₑₛₚₒₙₛₑ*N_{nodes})+(10%*N_{nodes}*(T_{request}+Tᵣₑₛₚₒₙₛₑ)))*2)+(((10%*N_{totalNodes})+N_{nodes})*T_{RouteDelay})

### Or

$$\begin{matrix}{T}_{transaction} = ( {T}_{transNoRoute} * 2 ) + \\ ( ( ( 10 \% * {N}_{totalNodes} ) + {N}_{node} ) * {T}_{RouteDelay} ) \\ = ( ( 70 ms + ( 200 ms * 25 ) + ( 2.5 * 270 ms ) ) * 2 ) + \\ ( ( 2.5 + 25 ) * 2 ms ) \\ = 11 , 490 ms + 55 ms \\ = 11 , 545\end{matrix}$$

There are 4 subnets that need to be routed once therefore:

$${N}_{subnet} = {N}_{total Subnets} * 20 \% = 4$$

$$\begin{matrix}No route total time = ( {N}_{subnet} * {T}_{transaction} ) / 2 \\ = 23 , 090 ms or 23 seconds\end{matrix}$$

### Two Routes

$$\begin{matrix}{T}_{transaction} = ( {T}_{transNoRoute} * 3 ) + \\ ( ( ( ( 10 \% * {N}_{totalNodes} ) * 2 ) + {N}_{node} ) * {T}_{RouteDelay} ) \\ = ( ( 70 ms + ( 200 ms * 25 ) + ( 2.5 * 270 ms ) ) * 3 ) + \\ ( ( ( 2.5 + 25 ) * 2 ) * 2 ms ) \\ = 11 , 490 ms + 55 ms \\ = 17235 + 125 \\ = 17 , 360 ms\end{matrix}$$

There are 4 subnets that need to be routed two times therefore:

$${N}_{subnet} = {N}_{total Subnets} * 20 \% = 4$$

$$\begin{matrix}No route total time = ( {N}_{subnet} * {T}_{transaction} ) / 2 \\ = 34 , 720 ms or 34.7 seconds\end{matrix}$$

### Three Routes

$$\begin{matrix}{T}_{transaction} = ( {T}_{transNoRoute} * 2 ) + \\ ( ( ( 10 \% * {N}_{totalNodes} ) + {N}_{subnet} ) * {T}_{RouteDelay} ) \\ = ( ( 70 ms + ( 200 ms * 25 ) + ( 2.5 * 270 ms ) ) * 4 ) + \\ ( ( 2.5 + 25 ) * 3 * 2 ms ) \\ = 22 , 980 ms + 165 ms \\ = 23 , 145\end{matrix}$$

There are 6 subnets that need to be routed three times therefore:

N_{subnet}=N_{totalSubnets}*30%=6

No route total time=(N_{subnet}*T_{transaction})/2=69,435 ms or 69.4 seconds

As would be apparent, for this example the system only allows for 1 retry for erroneous packets. Generally more retries are needed when meters cannot be reached.

The total time to read 500 meters consequently equals 144.3 seconds or 2.4 minutes. It is considered that this time comprises a substantial improvement over conventional systems.

FIG. 12 demonstrates how a meter can be used for both an AMR network and allow a consumer to read their energy usage from a computer or a display unit. Such a system would normally need two power line communication nodes to function. The example relates to bridging of two networks that operate on different parts of the spectrum as dictated by local regulatory bodies.

The system also allows the user to exchange modulation techniques between frequency shift keying (FSK) and phase shift keying (PSK). This functionality, in the embodiment described, is provided on the secondary channel and can be used as an extra level of redundancy. The use of FSK is advantageous for a number of reasons. Firstly, the method is not dependent on amplitude variations as is Amplitude shift keying (ASK). As mentioned previously the impedance of the power line is known to changes continuously and often abruptly and therefore the amplitude of the signal is accordingly often compromised. Unlike Differential Phase Shift Keying (DPSK) frequency shift keying does not effectively occupy twice the bandwidth as the carrier given that its complement does not have to be transmitted to generate a single bit. Notably DPSK overcomes the problem of phase distortion by comparing relative phases rather than an absolute phase and, in the case of phase inversions and other phase distortions, only one bit will be compromised and can be corrected with error correction algorithms. Furthermore, with DPSK error correction is often needed to correct for any instantaneous phase errors. Lastly, in the case of wide band spread spectrum devices, frequency ranges allocated are often different depending on the country of use and the approach is susceptible to deep frequency notches often found on the power line medium.

Due to FSK having its data encoded into frequency rather than phase it has a relatively high immunity to the phase distortion and thus is an advantageous aspect of the present embodiment.

FSK and BPSK accordingly complement each other by largely overcoming each others weaknesses. FIG. 14 demonstrates how the system operates. The Figure shows that when the primary frequency is blocked with phase distortion the secondary is used with FSK as the modulation and provides extra level of robustness.

In this embodiment non-coherent FSK demodulation is advantageously implemented.

Referring to FIG. 14 there is provided a device 200 according to another preferred embodiment of the present invention. The device 200 is provided in the form of an ASIC (application specific integrated circuit) having a phase modulation facility 202 for sending data in a phase shift keyed form; and a frequency modulation facility 204 for sending data in frequency shift keyed form. Included in the ASIC 200 is an interface facility 208 for adapting the phase modulation facility 202 and the frequency modulation facility 204 to operate over respective primary and redundant channels of a power transmission network 212.

The ASIC is provided in the form of an integrated computer chip 200 that provides part of a modulator 214. The modulator 214 in itself provides a further preferred embodiment of the present invention.

The phase modulation facility 202 is adapted to provide binary phase shift key modulation and the frequency modulation facility is adapted to provide non-coherent frequency shift key modulation. The device 200 is able to advantageously compensate for abrupt impedance variations caused by noise sources that would make binary phase shift key demodulation virtually impossible. As noted, abrupt impedance variation can make BPSK demodulation difficult with the phase variation often appearing to be valid data when demodulated.

Thus, the device 200 is capable of transferring data across an existing power line distribution network robustly using one of two modulation techniques (Frequency Shift Keying or Binary Phase Shift Keying) to propagate the data across the power line network on a carrier frequency. The two modulation techniques provide a system which is able to correct for errors on a complementary basis. The device combines both the BPSK and FSK Modulation and Demodulation to provide a resource efficient implementation.

As shown in FIG. 14, the device 200 includes a configuration facility 213 adapted to allow the user to exchange modulation techniques of the modulation facility 204 between FSK and PSK.

In this particular arrangement the configuration facility 213 switches the frequency modulation facility to a phase modulation facility whereby the phase modulation provided is Binary Phase Shift Keying. Frequency shift keying of the type detailed above is considered to be an advantageous and BPSK is given only as an example.

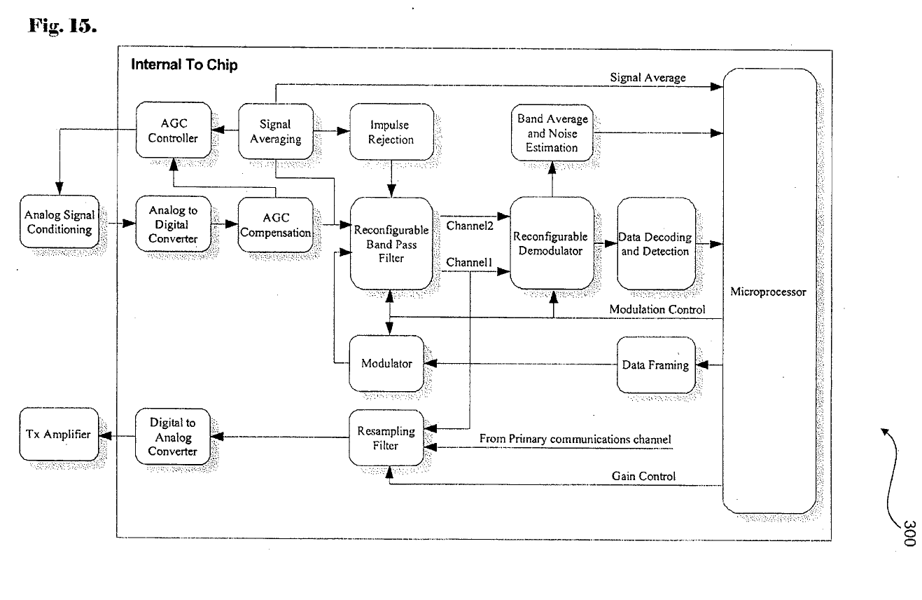

Referring to FIG. 15 there is shown a diagrammatic layout of a secondary receiver transmitter 300 according to another embodiment in which the FSK and BPSK demodulation systems are integrated into each other. The device 300 provides a preferred embodiment of the invention in which resources are advantageously shared.

In the device 300 non-coherent frequency shift key demodulation is achieved by measuring the power content of the two frequencies used for the FSK modulation. The magnitude of this power is then compared to detect the presence of a mark or space condition.

The signal firstly enters the system through an analog to digital converter (ADC). Before the analog signal enters the ADC it is conditioned as to remove frequencies significantly higher than the carrier frequency ensuring the eradication of any aliasing. This analog signal conditioning also contains an attenuator that is enabled when signals are larger that 1Vp−p. This enables large signals to enter the ADC without being distorted. The signal is measured through averaging the ADC's output and when the attenuation is enabled it is compensated to account for the change in amplitude. The converted analog signal then is checked for any signal anomalies before entering the filter.

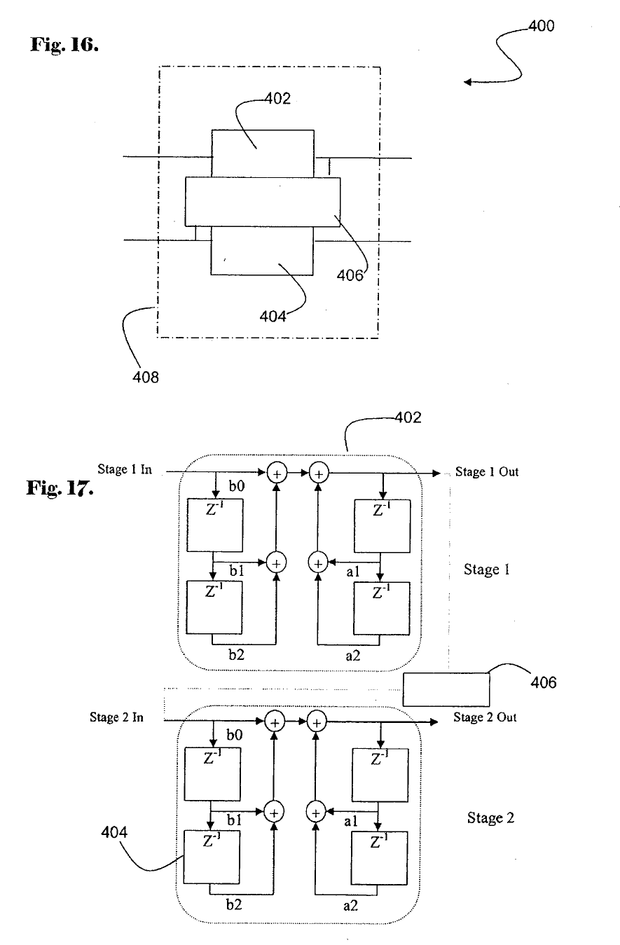

A further embodiment of the present invention is shown in FIGS. 16 and 17. The embodiment comprises a signal filter 400. As shown in the diagram the signal filter 400 comprises a first filter 402 and a second filter 404 and a coupler 406. The coupler 406 is arranged for selectively coupling the first filter 402 and the second filter 404 to provide a coupled filter 408.

The signal filter 400 is able to operate as either two independent filters 402, 404 or a single higher order filter 408. As shown in more detail in FIG. 17, the first filter 402 and the second filter 404 each comprise infinite impulse response filters of second order. The coupler 406 comprises a switch unit which is adapted to provide the coupled filter 408 as a coupled infinite impulse response filter of an order equal to the sum of the orders of the first and second filters 402 and 404. This reconfigurability and reuse of the signal filter logic has the benefit of significant area savings.

The signal filter 400 has the advantageous ability to become two independent filters or one higher order filter. This embodiment employs infinite impulse response filtering and has a number of advantages. Firstly there are fewer coefficients needed for the equivalent filter bandwidth as well as fewer registers for storage. The smaller number of coefficients was important as two sets of coefficients are stored into the re-configurable filter. The first set is used for BPSK receive/transmit and FSK transmit. This is discussed in more detail below. The second set is used for FSK receive.

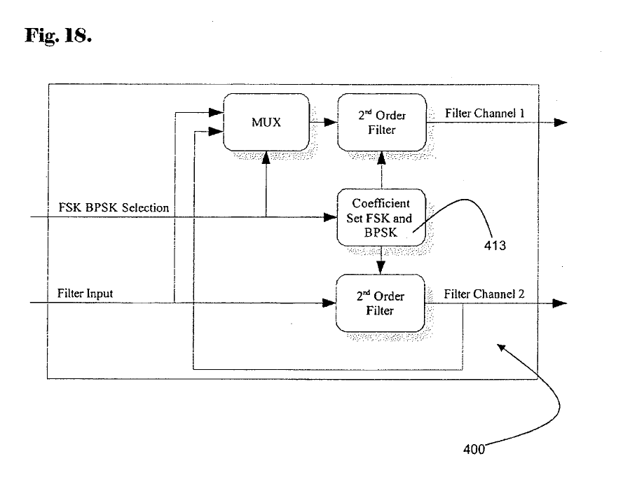

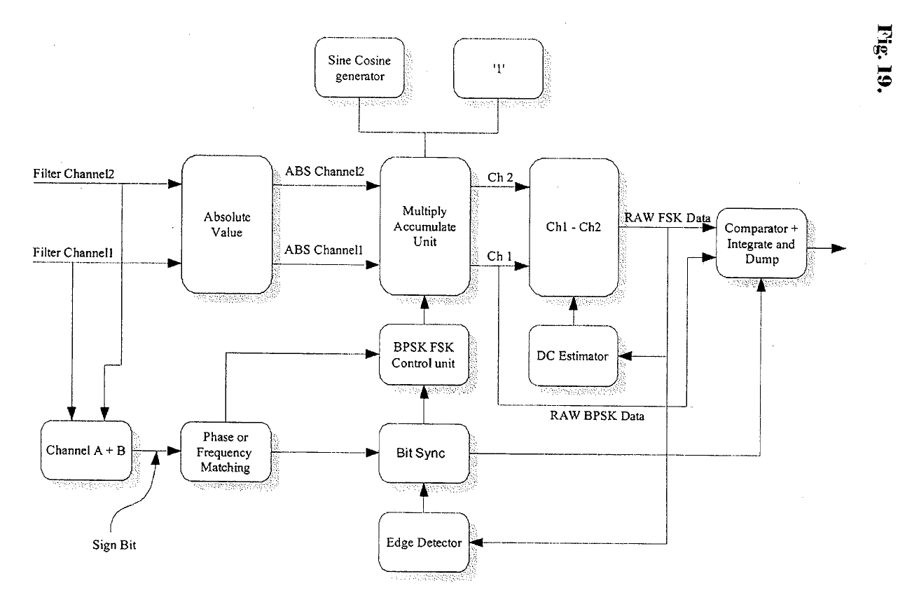

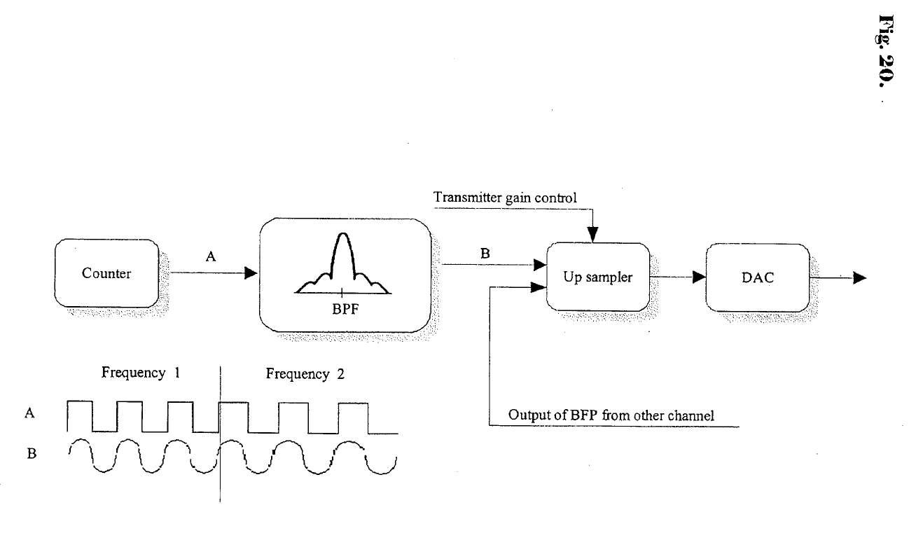

As shown in FIG. 18 the signal fitter 400 includes a data store 413 for filter coefficients wherein a first set of coefficients is used for phase shift keying and frequency shift keying transmission and a second of coefficients is used for frequency shift data. Due to the half duplex nature of the power line the filter is re-used.

The two second order filters are used in the demodulation of an incoming FSK signal. The first set of filter coefficients are calculated to have their centre frequencies exactly that of the mark and space frequencies of the FSK modulated signal. These provide match filtering and can be used to estimate the power contained within these two frequencies of interest. The power of the mark frequency is place into the filter channel 1 and the space frequency into filter channel 2 as shown in FIGS. 14 and 18. When BPSK is enabled the fitter places the two second order filters in series to provide the higher order filter and the second set of coefficients selected. This produces a very narrow fourth order filter that is centred around the BPSK signals carrier frequency. This reconfigurability enables the use of fewer resources while producing advantageous functionality.

As shown in FIG. 15, the signal is demodulated with a reconfigurable demodulation unit after it has been filtered. Advantageously the unit is designed to minimise the amount of logic used through reuse.

In the reconfigurable demodulation the absolute value of the filtered signal is taken first. This stage is only for FSK and is bypassed for BPSK demodulation. This absolute value (or bypassed signal) is placed into a multiply and accumulate unit (MAC unit) which contains a large shift register containing the sample to be processed. The MAC unit can be used in two ways. Firstly if it is used for BPSK the MAC unit is given a sine and cosine lookup table for phase comparison of the incoming BPSK signal. Secondly if FSK is selected then the multiplication is given a constant of 1. This makes the MAC unit simply act as an accumulator. The accumulation of the absolute samples provides envelope detection of the signal and therefore power estimation for that frequency. The control unit shown in FIG. 17 controls the operation of the MAC unit as well as phase estimation for BPSK.

In operation, channel 1 contains the raw data for BPSK and is passed onto the integrate and dump unit. The channels need further processing to demodulate the incoming FSK signal. The power containing within the two channels are compared through subtracting channel 1 from channel 2. To overcome effects of fading in the signal the DC or low frequency content of the signal is estimated. This occurs when either the mark or space frequency is subjected to attenuation or the signal fades in signal strength. This estimation is subtracted from the signal to produce a signal in which a decision between a mark and space can easily be made by looking at the sign bit.

In terms of the component modulators, according to embodiments of the present invention, many parts are reused. In this manner a modulator that is resource efficient and capable of producing both FSK and BPSK modulated signals is provided.

Regulations bodies such as CENELEC require very clean modulation signals with very little harmonic content. Also the amount of power contained within the spectral distribution of the modulation is also limited. This means the modulated signal must also be band limited. Due to the half duplex nature of the power line communications parts of the receiver can be used whilst transmitting. The BPF within the receiver as shown in FIG. 15 is reused for the purpose of band limiting the signal. Most clean sinusoidal signals are produced by creating a lookup table and replaying the contents through a DAC. This can be costly when there are many types of modulations as well as many possible frequencies of operation.

The BPSK signal is easily generated by placing a square wave into the same BPF that is used for reception. The phase change is produced by simply inverting the square wave signal. The square wave is generated by a counter that has a programmable wrapping value. This wrapping value is programmable through the network processor to produce the frequency desired. The FSK signal is produced in exactly the same manner. In the case of FSK there are two counter wrapping values stored (one for the mark frequency and the other for the space frequency). Notably, the BPSK carrier frequency must be exactly in the centre of the mark and space frequencies in order to produce FSK frequencies that are of the same amplitude. This is due to the same filter coefficients being used for the BPSK reception. The harmonics in the square wave are sufficiently filtered out producing a clean digital sine wave. FIG. 20 shows diagrammatically how the FSK frequency is generated in a modulator according to the embodiment.

After the band limited signal is produced from the BPF it is up sampled to a frequency that is a multiple of all possible used carrier frequencies. This is done for two reasons. Firstly this allows one DAC and up sampler to be used for the modulator instead of replicating the outputs. Secondly the higher frequency sample rate produced on the output of the DAC means that reconstruction filtering can be relaxed therefore making the overall cost of the communications device cheaper. Only first order filtering is needed to reduce alias frequencies to an acceptable level. The up sampler also contains a gain control for the transmitter that is used for regulating the output voltage under different load impedances.

The two filter channels are added together and the sign bit extracted. The sign bit is used to correlate a change from space to mark transition. When the transition from the space frequency to a mark frequency is correlated against the incoming signal a match will produce a large value otherwise the output value will be low. Bit synchronisation for BPSK is described in PCT/2006AU/000530 filed 27 Apr. 2006 in the name of the present applicant. The phase change matching method correlates the sign bit of the incoming signal with that of a phase change over the period of one symbol period. As noted above the disclosure of PCT/2006AU/000530 has been fully incorporated by reference.

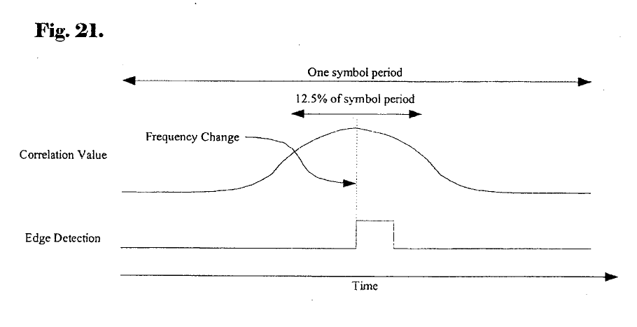

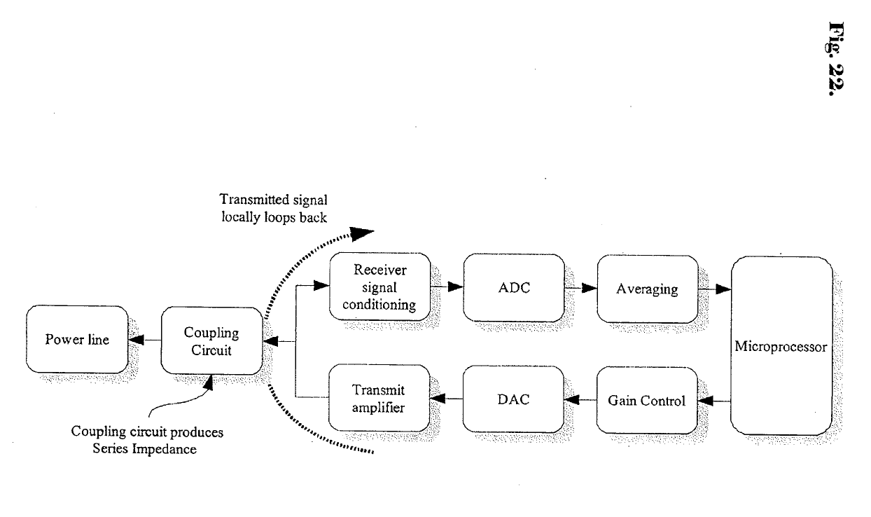

In the present embodiment, the method has been modified to look for frequency changes instead of phase changes. The two filter channels are added together and the sign bit extracted. The sign bit is used to correlate a change from space to mark transition. When the transition from the space frequency to a mark frequency is correlated against the incoming signal a match will produce a large value otherwise the output value will be low. FIG. 21 shows how the correlation value rises when a frequency change occurs.

The correlation for a frequency is not as strong as that of a phase change due to the mark and space being close in frequency. This means that jitter in the incoming signal can often correlate well and therefore false transitions can occur. For this reason an extra level of checking is provided. An edge detection circuit is placed on the output of the raw FSK data stream. If the edge in the raw data is within 12.5% (⅛) of a symbol period then it is considered to be a valid bit transition. This provides reliable and accurate bit syncing in the presence of significant noise that is often present on the power line medium. Other percentages of the symbol period may be employed.

At communication frequencies the power line communications channel often presents very low impedances. This presents two problems. Firstly high attenuation is produced due to low impedance devices creating voltage division effect with the impedance of power cables. Secondly any impedance placed in series with the transmitter and the power line will also have a large voltage division effect. These series impedance are often produced by coupling circuits, especially in the case of isolation where the series impedance can be in the order of 10 or 20 ohms. As the load increases on the power line less signal will be injected into the power line. The embodiment of the present invention addresses this problem by averaging as samples are taken off the power line through the analog to digital converter. This serves to produce a more consistent estimate of the incoming signal.

A voltage regulator system according to another embodiment is shown in FIG. 22. The voltage regulator system is configured such that in the case of transmission the signal is transmitted from the DAC into the transmitter amplifier but is then looped back through into the receiver. It forms a closed loop where the microprocessor has control over the loop. The average calculated from the ADC output is used to estimate the voltage drop across the coupling network. This is done by comparing the average voltage when the power line presents a high impedance (i.e. unloaded) to the current loading. The voltage after the coupling network can be estimated by using a voltage division calculation between the transmitters output impedance, the couplers impedance and the unknown power line impedance.

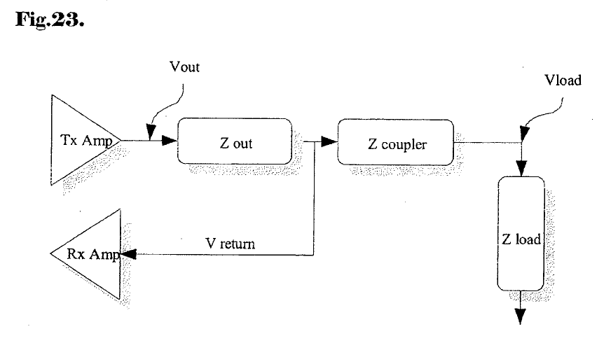

FIG. 23 demonstrates this circuit where Tx amp is the transmission amplifier, Z out is the output impedance of the transmit amplifier, Z coupler is the power line couplers impedance and Z load is the power line impedance. V out is the voltage of the transmit amplifier, vload is the voltage on the load and V return is the point at which the voltage is measure through the ADC. An example calculation may be as following using the derived formula:

$$\begin{matrix}Z out : & 1 ohm \\ Z couple : & 5 ohms \\ V out : & 7 Vp \text{-} p \\ V return : & 6 Vp \text{-} p \\ V load : & unknown\end{matrix}$$

$$V load = V return - ( ( \frac{V out - V return}{Z out} ) \times Z coupler \\ V load = 6 V - ( ( \frac{7 V - 6 V}{1} ) \times 5 ) \\ V load = 1 V$$

Using this equation the microprocessor can increase the gain of the transmitter. The parameters of Zout, Zcoupler and Vout are all dependent on the front end circuit used and must be changed for a specific design or simply disable any gain in the system where the impedance is not known. When BPSK is used a constant amplitude sinusoid is placed through the transmitter for the first 5 symbol periods to get an accurate reading of the Vreturn. FSK does not need this period as transmission provides a constant voltage. The algorithm should also have a voltage limit as the transmit amplifier has a maximum Vout or power output before damage occurs. Obviously other cycle periods may be used.

Most clean sinusoidal signals are produced by creating a lookup table and replaying the contents through a digital to analog converter. This can be costly when there are many types of modulations.

Thus the embodiments provide a dual modulation system developed for an ASIC in which the system allows the user to exchange modulation techniques between FSK and BPSK. That is the dual channel systems works with FSK as the modulation on a secondary redundant channel to overcome phase distortion. The narrow band filter used for binary phase shift key demodulation is, in some states, reused for the frequency shift key demodulation. This reuse of logic represents a significant saving in logic resources and cost.

It is to be understood that the present embodiment provides a unique manner of operating upon over a power line. This is despite power lines providing an inhospitable communications medium upon which simple communications systems often find it difficult communicate. The present embodiment provides a useful manner of addressing noise source including tones produced by power supplies, impulses, random voltage fluctuation, periodic bursts and so forth. Moreover, the presenting embodiment is useful in addressing the problem of impedance fluctuation. Other embodiments relate to subdivision of the network and other embodiment relate to correlation of frequency change.

As detailed above, the infinite impulse response filtering method is advantageous for a number of reasons. Firstly there are fewer coefficients needed for the equivalent filter bandwidth as well as fewer registers for storage. Secondly, and as described, rearranging the infinite impulse response filter into the sum of second order sections means that each filter can be sub-divided and reconfigured to realise two separate narrow band filters or a higher order single filter. The reconfigurability and reuse of logic has the benefit of significant area and cost savings.

Other embodiments and advantages will be apparent from a reading to the detailed description with reference to the drawings.

Summary of acronyms and abbreviations: PL—Power Line; PLI—Power Line Interface; Tx—Transmit; Rx—Receive; ASIC—Application specific integrated circuit; SNR—Signal to Noise Ratio; MAC—Medium Access Control; Node—a single end point on the power line network that is capable of transmitting and receiving data; BPSK—Binary Phase Shift Keying; FSK—Frequency Shift Keying; ASK—Amplitude Shift Keying; DPSK—Differential Phase Shift Keying; BPF—Band Pass Filter.

It is to be appreciated that the embodiments have a number of aspects. For example in some of the aspects there are provided communication devices and/or methods adapted for the automatic meter reading, data concentrator, home gateway, IR gateway and home automation, such as by way of example power point, light switches, curtain control, gas valve control, air conditioner and heater control, remote device and/or appliance control and/or industrial control markets. In aspects the invention and one or any combination of its aspects may reside in a power line modem or power line modem software. The disclosure of PCT/AU2006/000530, filed 26 Apr. 2006, has been incorporated by reference.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

It should be noted that where the terms “server”, “secure server” or similar terms are used herein, a communication device is described that may be used in a communication system, unless the context otherwise requires, and should not be construed to limit the present invention to any particular communication device type. Thus, a communication device may include, without limitation, a bridge, router, bridge-router (router), switch, node, or other communication device, which may or may not be secure.

It should also be noted that where a flowchart is used herein to demonstrate various aspects of the invention, it should not be construed to limit the present invention to any particular logic flow or logic implementation. The described logic may be partitioned into different, logic blocks (e.g., programs, modules, functions, or subroutines) without changing the overall results or otherwise departing from the true scope of the invention. Often, logic elements may be added, modified, omitted, performed in a different order, or implemented using different logic constructs (e.g., logic gates, looping primitives, conditional logic, and other logic constructs) without changing the overall results or otherwise departing from the true scope of the invention.

Various embodiments of the invention may be embodied in many different forms, including computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In an exemplary embodiment of the present invention, predominantly all of the communication between users and the server is implemented as a set of computer program instructions that is converted into a computer executable form, stored as such in a computer readable medium, and executed by a microprocessor under the control of an operating system.

Computer program logic implementing all or part of the functionality where described herein may be embodied in various forms, including a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM or DVD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and inter-networking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality where described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM or DVD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

“Comprises/comprising” when used in this specification is taken to specify the presence of stated features, integers, steps or components but does not preclude the presence or addition of one or more other features, integers, steps, components or groups thereof.” Thus, unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

1. A power lines communication device comprising a communications unit having a first channel unit and a second channel unit wherein the channel units are adapted, in a first mode of operation, to receive simultaneously and/or transmit simultaneously.

2. A power lines communication device as claimed in claim 1 wherein the device comprises an automatic meter reading device for a power line network and the channel units are adapted, in a first mode of operation, to either receive simultaneously or transmit simultaneously.

3. A power line communication device as claimed in claim 1 wherein the communication unit is configured to operate in an automatic meter reading network divided into at least two sub networks.

4. A power line communication device as claimed in claim 3 wherein the subnetworks are each associated with a respective unique frequency providing frequency division and concurrent operation.

5. A power line communication device as claimed in claim 1 wherein the first channel unit is configured for handling utility traffic and the second channel unit is configured handling for consumer traffic using frequencies ranges mandated by regulatory bodies.

6. A power line communication device as claimed in claim 1 wherein the second channel unit is configured for a different modulation technique to the first channel unit.

7. A power line communication device as claimed in claim 1 including a control unit for switching the second channel unit between being configured for frequency shift keying and phase shift keying.

8.-26. (canceled)

27. A method of querying a plurality of utility meters comprising:
maintaining a record of divisions of the utility meters;
querying a first division of the divisions in accordance a first signalling method; and
querying a second division of the divisions in accordance with a second signalling method.

28. A method as claimed in claim 27 wherein the first signalling method comprises phase shift keying.

29. A method as claimed in claim 27 or wherein the second signalling method comprises frequency shift keying.

30. A method as claimed in claim 27 including time sharing the querying of the first and second divisions.

31. A method as claimed in claim 27 including concurrently the querying of the first and second divisions.

32. (canceled)

33. A method as claimed in claim 27 wherein the first signalling method is associated with a first frequency and the second signalling method is associated with a second frequency.

34. (canceled)

35. A device for querying a plurality of utility meters comprising:
a store for maintaining a record of divisions of the utility meters; and
a query unit having a first facility for querying a first division of the divisions in accordance a first signalling method and a second facility for querying a second division of the divisions in accordance with a second signalling method.

36. A device as claimed in claim 35 wherein the first facility is configured for phase shift keying.

37. A device as claimed in claim 35 wherein the second facility is configured for frequency shift keying.

38. A device as claimed in claim 35 including means for time sharing the querying of the first and second divisions.

39. A device as claimed in claim 35 including a configuration facility for selective configuring the second facility for querying a second division of the divisions in accordance with a selected one of a plurality of signalling methods.

40. A device as claimed in claim 35 wherein the first signalling method is associated with a first frequency and the second signalling method is associated with a second frequency.

41. A device as claimed in claim 35 wherein the first and second signalling methods are selected to increase throughput.

42.-50. (canceled)
